(19) United States
(12) Patent Application Publication
(10) Pub. No.: US 2021/0130204 A1
(43) Pub. Date: May 6, 2021

(54) BACTERIA-BASED CATALYSTS AND METHOD OF MAKING

(71) Applicant: King Abdullah University of Science and Technology, Thuwal (SA)

(72) Inventors: Shafeer Kalathil, Thuwal (SA); Krishna P. Katuri, Thuwal (SA); Pascal E. Saikaly, Thuwal (SA)

(21) Appl. No.: 17/046,558

(22) PCT Filed: Apr. 9, 2019
(86) PCT No.: PCT/IB2019/052923

§ 371 Date: Oct. 9, 2020

Related U.S. Application Data
(60) Provisional application No. 62/654,686, filed on Apr. 9, 2018.

(51) Int. Cl. C02F 3/00; C02F 1/72; C02F 3/34; C25B 1/04; C25B 11/073

(52) U.S. Cl. CPC C02F 3/005; C02F 1/725; C02F 2101/306; C25B 1/04; C25B 11/073; C02F 3/348

(57) ABSTRACT

Bacteria-based catalysts including a bacterium and one or more metal oxides are disclosed. The metal oxides are dispersed on the surface of the bacterium. The bacterium can be an electrogenic bacterium, which employs an extracellular electron transport pathway to transfer metabolically generated electrons to cell-exterior. The bacteria-based catalysts can be made by: (a) oxidizing a substrate molecule by a bacterium to generate electrons; (b) transporting the electrons to one or more metal oxide precursors; and (c) reducing the metal oxide precursors to metal oxides. The bacteria-based catalysts disclosed herein can be used in electrocatalysis, photocatalysis, or chemical catalysis. For example, they can catalyze oxygen evolution reaction (OER) and outperform commercial metal oxide catalyst for OER with superior operational stability.

### RELATED APPLICATION

This application claims priority to U.S. Provisional Patent Application No. 62/654,686, filed on Apr. 9, 2018, the content of which is incorporated herein by reference in its entirety.

### FIELD OF THE INVENTION

The invention is in the field of catalysts, particularly bacteria-based metal oxide catalysts derived from electrogenic bacteria and their methods of making and using thereof.

### BACKGROUND OF THE INVENTION

Water is abundant and considered as one of the cheapest source of electrons. Water oxidation is the key reaction in artificial photosynthesis by serving as a source of electrons to produce either hydrogen or to reduce carbon dioxide (CO₂) to value-added chemicals (e.g., acetate and butanol) (Najafpour, et al., Chem. Rev., 116:2886-2936 (2016); Gildemyn, et al., Environ. Sci. Technol. Lett., 2:325-328 (2015)). However, water oxidation is thermodynamically not feasible and needs large amount of energy (Najafpour, et al., Chem. Rev., 116:2886-2936 (2016)). Catalysts can play significant role in water oxidation by lowering the overpotential to split water (Hunter, et al., Chem. Rev., 116:14120-14136 (2016)). Metal oxides of ruthenium, iridium and manganese are the most common electrocatalysts employed for water oxidation (Smith, et al., Science, 340:60-63 (2013)). However, high cost and low abundance of ruthenium and iridium based oxides hinder the practical application of these materials in water oxidation (Smith, et al., Science, 340:60-63 (2013)).

Manganese oxides are highly attractive owing to their low cost and earth abundance (Menezes, et al., ChemSusChem, 7:2202-2211 (2014)). Manganese based complex is the water oxidation unit in natural photosynthesis (PS II) and hence manganese is the natural choice for the water oxidation (Najafpour, et al., Inorg. Chem., 55:8827-8832 (2016)). Manganese oxides can stay at various oxidation states (+2, +3 and +4). Among them, manganese oxide having +3 oxidation instance of Mn (i.e. Mn₂O₃) acts as an efficient electro-catalyst for water oxidation (Takashima, et al., J. Am. Chem. Soc., 134:1519-1527 (2012); Mattioli, et al., J. Am. Chem. Soc., 137:10254-10267 (2015)). Synthesis of Mn₂O₃ nanocrystals starting from KMnO₄ (as precursor) usually needs rigorous reaction conditions and copious amount of toxic chemicals such as hydrazine (Ahmed, et al., Journal of Taibah University for Science, 10:412-429 (2016)). Also, most of the synthetic routes provide crystalline Mn₂O₃ nanostructures which are less efficient for OER as compared to amorphous structures.

Geobacter sulfurreducens PCA is a dissimilatory metal reducing bacterium and abundant in natural sediments and wastewater (Methé, et al., Science, 302:1967-1969 (2003)). G. sulfurreducens can use varieties of electron acceptors with reduction potential window varying from −0.4 V to +0.8 V vs. SHE, such as fumarate, metal oxides, charged electrodes, oxygen, etc. (Kalathil, et al., RSC Adv., 6:30582-30597 (2016)). This bacterium employs a unique respiratory pathway, namely extracellular electron transport (EET) pathway to transfer metabolically generated electrons to cell-exterior (Lovley, Annu. Rev. Microbiol., 66:391 (2012); Kalathil, et al., RSC Adv., 6:30582-30597 (2016)). Recent studies have demonstrated that nanowires produced by G. sulfurreducens show metallic conductivity (Malvankar, et al., Nat. Nanotechnol., 6:573 (2011)) and outer membrane c-type cytochromes (OM c-Cyts) of the bacterium behave as supercapacitors (Malvankar, et al., ChemPhysChem, 13:463-468 (2012)).

There remains a need for catalysts with improved catalytic activity such as lower overpotential at a given current density and improved stability. Another desired aspect is methods of making such catalysts that are simple, eliminate the use of toxic reagents, can be performed under ambient conditions, and produce catalysts with undetectable levels of impurities.

Therefore, it is the object of the present invention to provide catalysts with improved catalytic activity.

It is another object of the present invention to provide methods of making the catalysts with improved catalytic activity.

It is yet another object of the present invention to provide methods of using the catalysts with improved catalytic activity.

### SUMMARY OF THE INVENTION

Bacteria-based catalysts with improved catalytic activity, and methods of making and using are provided.

The bacteria-based catalysts include a bacterium and one or more metal oxides. The metal oxides are dispersed on the surface of the bacterium. Preferably, the metal oxides are dispersed uniformly on the surface of the bacterium. In some instances, the bacterium is an electrogenic bacterium. In some instances, the metal oxides can contain the same metal or at least two different metals. In some instances, the metal oxides contain one or more transition metal. In some instances, the metal oxides are doped with one or more elements other than the metal. In some instances, the metal oxides are in amorphous phase. In a particular instance, the bacterium is Geobacter sulfurreducens and the metal oxide is Mn₂O₃.

Also provided are methods of making the bacteria-based catalysts, which include a bacterium and one or more metal oxides. The bacteria-based catalysts can be made by: (a) oxidizing a substrate molecule by a bacterium to generate electrons; (b) transporting the electrons to one or more metal oxide precursors; and (c) reducing the metal oxide precursors to metal oxides. The substrate molecule is generally any molecule that is capable of being oxidized by a bacterium, resulting in donating electrons to the bacterium. In a particular instance, the substrate molecule is acetate. Generally, the metal oxide precursors are capable of accepting electrons from the bacterium, resulting in reduction of the metal oxide precursors to metal oxides. In a particular instance, the metal oxide precursor is potassium permanganate. In some instances, the bacterium is bifunctional: (1) serving as a reducing agent in the synthesis of the metal oxides; and (2) serving as the supporting materials for the as-synthesized metal oxides.

The bacteria-based catalysts disclosed herein can be used in electrocatalysis, photocatalysis, or chemical catalysis. In some instances, the bacteria-based catalysts employed in catalysis contain the same type of bacteria. In some instances, the bacteria-based catalysts employed in catalysis contain a plurality of at least two different types of bacteria. In a particular instance, the bacteria-based catalysts disclosed herein catalyze oxygen evolution reaction (OER) and outperform commercial metal oxide catalysts for OER with operational stability for at least 24 hours.

### BRIEF DESCRIPTION OF THE DRAWINGS

FIG. 1 is a schematic representation of the biosynthesis process of Mn₂O₃ nanocrystals.

FIG. 2 is a graph showing the EDX spectrum of B—Mn₂O₃ nanocrystals.

FIG. 3A is a graph showing the electron energy loss spectrum (EELS) obtained from O-K edge of the B—Mn₂O₃ nanocrystals. FIG. 3B is graph showing the EELS obtained from Mn-L₂ edge and Mn-L₃ edge of the B—Mn₂O₃ nanocrystals.

FIG. 4 is a graph showing the XRD plot of B—Mn₂O₃ nanocrystals. FIG. 5A is a graph showing the linear sweep voltammetry (LSV) curves for oxygen evolution reaction (OER) activities of B—Mn₂O₃ nanocrystals, commercial Mn₂O₃ nanoparticles, and glassy carbon (GC) in 1 M KOH at a scan rate of 10 mV/s. FIG. 5B is a graph showing the chronoamperometry curve of B—Mn₂O₃ nanocrystals by applying an overpotential of 390 mV vs. RHE.

### DETAILED DESCRIPTION OF THE INVENTION

### I. Definitions

As used herein, the term “ambient condition” refers to a condition where the temperature is about 30° C., under atmospheric pressure.

As used herein, the term “close proximity” refers to a distance which electron transfer is permitted through direct or indirect electron transfers.

As used herein, the term “electrocatalyst” refers to a catalyst that participates in an electrochemical reaction and serves to reduce activation barriers of a half-reaction, and thus, reduces the overpotential of said reaction.

As used herein, the term “electrolyte solution” refers to a solution that contains ions, atoms, or molecules that have lost or gained electrons, and is electrically conductive.

As used herein, the term “improved catalytic activity” in connection with bacteria-based catalysts include lower overpotential at a given current density or increased reaction rate, and/or improved operational stability.

As used herein, the term “operational stability” refers to the bacterium-based catalyst's capability to preserve the original current density in a catalytic reaction.

As used herein, the term “overpotential” refers to the potential difference between a half-reaction's thermodynamically determined reduction potential and the potential at which the reaction is experimentally observed, and thus describes the cell voltage efficiency. The overpotenail over comes various kinetic activation barriers of the electrolytic cell and varies between cells and operation conditions.

As used herein, the term “photocatalyst” refers to a catalyst that participates in a photoreaction and serves to increase the reaction rate of said photoreaction.

As used herein, the term “uniformly dispersed” refers to a distribution of the metal oxides deposited on the surface of the bacterium without large variations in the local concentration across the accessible bacterium surface.

Numerical ranges disclosed in the present application include, but are not limited to, ranges of temperatures, ranges of concentrations, ranges of integers, ranges of times, and ranges of temperatures, etc. The disclosed ranges of any type, disclose individually each possible number that such a range could reasonably encompass, as well as any sub-ranges and combinations of sub-ranges encompassed therein. For example, disclosure of a temperature range is intended to disclose individually every possible temperature value that such a range could encompass, consistent with the disclosure herein.

Use of the term “about” is intended to describe values either above or below the stated value, which the term “about” modifies, in a range of approx. +/−10%; in other instances the values may range in value either above or below the stated value in a range of approx. +/−5%. When the term “about” is used before a range of numbers (i.e., about 1-5) or before a series of numbers (i.e., about 1, 2, 3, 4, etc.), it is intended to modify both ends of the range of numbers or each of the numbers in the series, unless specified otherwise

### II. Bacteria-Based Catalysts

The Examples below demonstrated for the first time bacteria-based catalysts, i.e. amorphous Mn₂O₃ nanocrystals directly synthesized by bacteria (B—Mn₂O₃), and their use in water oxidation as an outstanding electrocatalyst. The disclosed bacteria-based catalysts, i.e. B—Mn₂O₃. is highly effective for oxygen evolution reaction (OER). The method of making such bacteria-based catalysts, i.e. microbial mediated biosynthesis of Mn₂O₃ nanocrystals, eliminated the use of toxic reagents, can be performed under ambient conditions, and produced metal oxides, i.e. Mn₂O₃ nanocrystals, with undetectable levels of impurities. In the Examples, G. sulfurreducens was employed to synthesize manganese oxide nanocrystals by employing acetate as sole electron donor (substrate molecule) and KMnO₄ as the sole electron acceptor (metal oxide precursor). As-synthesized manganese oxide showed a crystal structure of Mn₂O₃ with amorphous phase. The bacteria are bifunctional: (1) serving as reducing agent in the synthesis of Mn₂O₃ nanocrystals; and (2) serving as the supporting materials for the as-synthesized Mn₂O₃ nanocrystals, i.e. as carbon support. It was demonstrated that such bacteria-based catalysts outperform commercial metal oxide nanocrystals for OER and shows operational stability for at least 24 hours.

The disclosed bacteria-based catalysts include a bacterium and one or more nanostructured metal oxides, where the metal oxides are dispersed on the surface of the bacterium. In some instances, the one or more metal oxides are dispersed uniformly on the surface of the bacterium. In some instances, the uniform dispersion of the metal oxides is characterized by small variations in the local concentrations of the metal oxides on the surface of the bacterium. In some instances, the local concentration of dispersed metal oxides can vary by 40% or less, by 35% or less, by 20% or less, by 10% or less, or by 5% or less. In some instances, the local concentration of dispersed metal oxides on the surface of the bacterium can be measured by high angle annular dark field (HAADF) imaging, TEM, SEM, EDX, or combinations thereof. In some instances, the one or more metal oxides are dispersed non-uniformly on the surface of the bacterium.

In some instances, the one or more metal oxides cover at least 10%, at least 20%, at least 40%, at least 50%, at least 60%, at least 70%, at least 80%, at least 90%, or at least 95% of the total surface area of the bacterium. In some instances, the one or more metal oxides cover between 50% and 95%, between 50% and 90%, between 60% and 95%, between 60% and 90%, between 70% and 95%, between 70% and 90%, between 80% and 95%, or between 80% and 90% of the total surface area of the bacterium

In some instances, the disclosed bacteria-based catalysts can be electrocatalysts or photocatalysts. In some instances, the bacteria-based catalysts are electrocatalysts. In some instances, the bacteria-based catalysts can catalyze an oxygen evolution reaction (OER) and/or an oxygen reduction reaction (ORR). In some instances, the bacteria-based catalysts can catalyze an OER with higher efficiency. For example, by selecting materials for the bacterium and metal oxides as disclosed herein, the bacteria-based catalysts employing the disclosed components have demonstrated a current density of 10 mA/cm² at an overpotential of about 390 mV vs. RHE, which is about 20% lower in overpotential compared to that of commercial metal oxide catalysts. Additionally, the bacteria-based catalysts show superior operational stability, i.e. it preserves the anodic current in OER at the original level for at least 24 hours.

Generally, the metal oxides can have a MₓO_{y} type structure, where x is an integer between 1 and 3, and y is an integer between 1 and 4. In some instances, x is 2 and y is 3. In some instances, the metal oxides can include O_{y} itself or MₓO_{y} doped with one or more elements other than M. In some instances, the one or more metal oxides contain the same metal. In some instances, the one or more metal oxides contain at least two different metals. In some instances, the MₓO_{y} type structure can have a nanostructure. In some instances, the MₓO_{y} type structure can be crystalline or amorphous. In some instances, the MₓO_{y} type structure is in amorphous phase. In some instances, the MₓO_{y} type structure can have a diameter of its largest projection area in the nanometer range, i.e. between 1 and 500 nm. In some instances, the metal oxide can have a diameter of its largest projection area between 1 and 100 nm, between 1 and 50 nm, between 1 and 20 nm, between 1 and 10 nm, or between 5 and 10 nm.

In some instances, the MₓO_{y} type structure includes MₓO_{y} itself. In some instances, the metal (M) of the MₓO_{y} contains one or more transition metals. Exemplary metal oxide includes, but is not limited to, chromium oxide, manganese oxide, iron oxide, cobalt oxide, nickel oxide, copper oxide, zinc oxide, ruthenium oxide, rhodium oxide, palladium oxide, silver oxide, cadmium oxide, iridium oxide, platinum oxide, and gold oxide. In some instances, the metal oxide is manganese oxide in the form of MnO, Mn₂O₃. MnO₂, or Mn₃O₄. In some instances, the manganese oxide is in the form of Mn₂O₃.

In some instances, the metal oxide is doped with one or more elements other than M. In some instances, the one or more elements other than M can be, but are not limited to, aluminium, indium, gallium, silicon, tin, chromium, manganese, iron, cobalt, nickel, copper, zinc, ruthenium, rhodium, palladium, silver, cadmium, iridium, platinum, gold, potassium, carbon, phosphorous, sulfur, fluorine, chlorine, bromine, and iodine.

Generally, the bacterium is abundant in nature and non-pathogenic. In some instances, the disclosed bacterium is an electrogenic bacterium. The electrogenic bacterium can employ an extracellular electron transport (EET) pathway to transfer metabolically generated electrons to cell-exterior. Metal oxide precursors surrounding the exterior of the bacterium cell can accept the electrons and get reduced to metal oxides. The bacterium disclosed herein can be bifunctional: (1) serving as reducing agent in the synthesis of metal oxides; and (2) serving as the supporting materials for the as-synthesized metal oxides, i.e. as carbon support. Exemplary electrogenic bacterium includes, but are not limited to, Geobacter sulfurreducens, Desulfuromonas acetexigens, Geobacter metallireducens, Shewanella oneidensis MR-1, Shewanella putrefaciens IR-1, Clostridium butyricum, Rhodoferax ferrireducens, Aeromonas hydrophilia (A3), Desulfobulbus propionicus, Shewanella oneidensis DSP10, Rhodoseudomonas palustris, Geothrix fermentans, and Geopsychrobacter electrodiphilus. In some instances, the electrogenic bacterium is Geobacter sulfurreducens.

### III. Methods of Making the Bacteria-Based Catalysts

Bacteria-based catalysts disclosed herein include a bacterium and one or more metal oxides. The one or more metal oxides are dispersed on the surface of the bacterium. Methods of making the disclosed bacteria-based catalysts are provided herein, which advantageously eliminate the use of toxic reagents, can be performed under ambient conditions, and produce metal oxides with undetectable levels of impurities. In some instances, a method of making the bacteria-based catalysts includes the steps of:

(a) oxidizing a substrate molecule by a bacterium to generate electrons;

(b) transporting the electrons to one or more metal oxide precursors; and

(c) reducing the metal oxide precursors to metal oxides.

In some instances, steps (a)-(c) can be performed in an anaerobic environment. In some instances, steps (a)-(c) can be performed at a temperature between about 20° C. and about 40° C., between about 25° C. and 35° C., between about 25° C. and about 30° C. In some instances, steps (a)-(c) can be performed under ambient condition. In some instances, steps (a)-(c) can be performed in a dark environment to avoid direct light. In some instances, steps (a)-(c) can be performed in a period between about 6 hours and about 90 hours, between about 10 hours and about 80 hours, between about 20 hours and about 75 hours, between about 24 hours and about 72 hours, between about 48 hours and about 72 hours. In some instances, steps (a)-(c) can be performed at about 30° C. for about 72 hours. In some instances, steps (a)-(c) can be performed at about 30° C. in dark for about 72 hours. In some instances, steps (a)-(c) can be performed in a cell growth medium or in dry form. In some instances, steps (a)-(c) are performed in a cell growth medium. Suitable cell growth medium includes, but is not limited to, LB broth, LB Agar, Terrific broth, M9 minimal, MagicMedia medium, and ImMedia medium. In some instances, the cell growth medium is anaerobic and sterile. The cell growth medium can have a pH between about 6 and about 9, between about 6 and about 8, or between about 7 and about 8. In some instances, the cell growth medium can have a pH about 7.4.

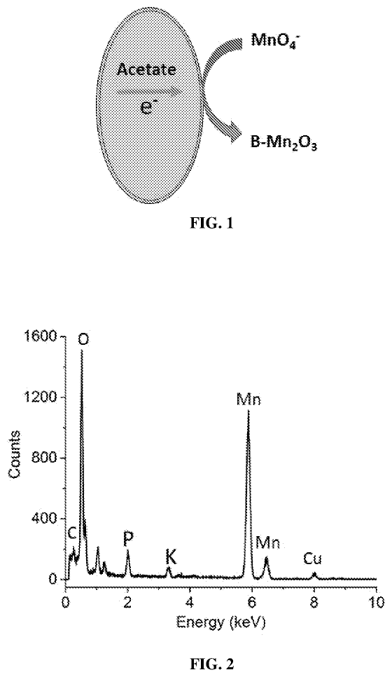

In some instances, the bacterium can be any electrogenic bacterium described above. The electrogenic bacterium can employ an extracellular electron transport pathway to transfer metabolically generated electrons to cell-exterior. The bacterium disclosed herein can be bifunctional: (1) serving as reducing agent in the synthesis of metal oxides; and (2) serving as the supporting materials for the as-synthesized metal oxides, i.e. as carbon support. It is believed that electrogenic bacteria, such as those described above, include a plurality of cytochromes (associated on their outer membranes). Such cytochromes (multiheme c-type cytochromes) allow for reduction of molecules outside the cell membrane (See FIG. 1). Outer membrane c-type cytochromes can include, for example, OmcE, OmcS, OmcZ, OmcA, ppcA, and mtrA, which are capable of extracellular electron transfer.

In some instances, it is possible to control the density of the metal oxides, which are formed on the cell surface of the electrogenic bacterium, by selectively overexpressing the cytochromes to increase their surface density and subjecting bacterium cell with overexpressed cytochromes to electron acceptors, i.e. metal oxide precursors, and subsequently using the over-expressed cytochrome cells for the synthesis of metal oxides on the surface of the bacterium cell with the aim of increasing and/or controlling their density. In some instances, the density of metal oxides formed on the bacterium surface of the electrogenic bacterium can be controlled as a function of concentration of substrate molecule, metal oxide precursors, reaction time, and combinations thereof.

A substrate molecule is necessary in making the bacteria-based catalysts as a source of electrons. Generally, the substrate molecule is any molecule that is capable of being oxidized by a bacterium, resulting in donating electrons to the bacterium. Exemplary substrate molecule includes, but is not limited to, acetate, hydrogen, lactate, pyruvate, instanceate, phosphite, sulfur, sulfite, or thiosulfate. In some instances, the substrate molecule is acetate. In some instances, the substrate molecule can have a concentration between about 10 mM and about 50 mM, between about 20 mM and about 50 mM, between about 10 mM and about 40 mM, between about 10 mM and about 30 mM, between about 10 mM and about 20 mM. In some instances, the substrate molecule has a concentration ≤20 mM to avoid toxicity for the extracellular electron transfer process. In some instances, the substrate molecule can have a concentration of about 20 mM.

Generally, metal oxide precursors are capable of accepting electrons from the bacterium, resulting in reduction of the metal oxide precursors to metal oxides. The metal oxide precursors can be solid or soluble in a medium. In some instances, the metal oxide precursors are soluble in a medium at a concentration between about 5 mM and about 20 mM, between about 5 mM and about 15 mM, between about 5 mM and about 10 mM, between about 5 mM and about 8 mM. In some instances, the metal oxide precursors can have a concentration of about 5 mM. In some instances, the metal oxide precursors can be salts of the corresponding metal oxides. For example, the precursor of Mn₂O₃ can be potassium permanganate (KMnO₄). The one or more metal oxide precursors can contain a single type of metal or at least two different types of metals. In some instances, the metal can be any transition metal described above. In some instances, the metal oxide precursors have a reduction potential between about −0.4 V and about +0.8 V vs. SHE. Alternatively, in some instances, the metal oxide precursors can be deposited directly on dried bacterium to accept electrons and form the metal oxides.

In some instances, the metal oxide precursors soluble in medium can be in close proximity to the surface of the bacterium to accept electrons from the bacterium. In some instances, the metal oxide precursors are in direct contact with the surface of the bacterium to accept electrons from the bacterium. In some instances, the electrons are transferred directly from the bacterium to the metal oxide precursors. Optionally, an electron mediator can be used in step (b). The electron mediator is a compound that can accept and/or donate electrons. The electron mediators can be in close proximity to the surface of the bacterium and the metal oxide precursors, and act as a bridge to facilitate indirect electron transfer between the bacterium and the metal oxide precursors. Exemplary electron mediator includes, but are not limited to, pyrroloquinoline quinone (PQQ), phenazine methosulfate, dichlorophenol indophenol, short chain ubiquinones, potassium ferricyan, or equivalents of each. In some instances, the metal oxides formed in step (c) are distributed uniformly on the surface of the bacterium.

Optionally, an isolation step can be performed following step (c). Suitable means for isolation of the resulting bacteria-based catalysts include, but are not limited to centrifugation, filtration, dialysis, or a combination thereof. Optionally, the isolated bacteria-based catalysts can be subsequently washed with a solvent and dried by a suitable means. One or more washings of the bacteria-based catalysts can be performed to remove impurities, i.e. media components, present in the resulting bacteria-based catalysts. Suitable solvent for washing includes, but is not limited to water, deionized water, salt water, phosphate buffer solution (PBS), MES buffer, Bis-Tris buffer, ADA, ACES, PIPES, MOPSO, Bis-Tris propane, BES, MOPS, TES, HEPES, DIPSO, MOBS, TAPSO, Trizma, HEPPSO, POPSO, TEA, EPPS, Tricine, Gly-gly, Bicine, HEPBS, TAPS, AMPD, TABS, AMPSO, CHES, CAPSO, AMP, CAPS, CABS, or a combination thereof. In some instances, the solvent for washing is water, ethanol, or a combination thereof. In some instances, the solvent for washing is water. In some instances, the solvent for washing is ethanol. In some instances, the solvent for washing is not a buffer. Washing with buffer may cross contaminate the catalysts with buffer components. Drying the bacteria-based catalysts can be accomplished by any suitable means, which includes, but is not limited to, heating to a suitable temperature, lyophilizing the bacteria cells, and air-dry. Suitable temperature for drying can be a temperature between about 20° C. and about 45° C., between about 25° C. and about 45° C. , between about 35° C. and about 45° C. The drying step can be performed in a period between about 2 and about 24 hours, between about 5 and about 20 hours, between about 5 and about 15 hours, and between about 10 and about 15 hours. In some instances, the bacteria based catalysts are dried at about 40° C. for overnight.

The resulting bacteria-based catalysts prepared by the above method can be characterized by such methods including, but not limited to, HAADF imaging, electron microscopy (i.e., TEM, SEM, STEM), selected area electron diffraction (SAED), X-ray diffraction (XRD), X-ray Photoelectron Spectroscopy (XPS), Energy dispersive X-ray (EDX), EELS, Raman spectroscopy, Brunaer-Emmett-Teller (BET), Inductively coupled plasma atomic/mass emission spectroscopy (ICP-OES/MS), X-ray absorption spectroscopy (XAS), Diffuse reflectance infrared Fourier transinstance spectroscopy (DRIFTS), Chronoamperometry, Linear sweeping voltammetry (LSV), etc. to establish the properties of the catalyst prepared.

### IV. Methods of Using the Bacteria-Based Catalysts

The bacteria-based catalysts described herein and prepared according to the methods above have metal oxides present on the surface of a bacterium. The bacterium acts as both a reducing agent for producing the metal oxides, and as a carbon support for the metal oxides in catalytic reactions. The bacteria-based catalysts can be used in electrocatalysis, photocatalysis, or chemical catalysis. In some instances, bacteria-based catalysts employed in catalysis contain the same type of bacteria. In some instances, the bacteria based catalysts employed in catalysis contain a plurality of at least two different types of bacteria.

In some instances, the bacteria-based catalysts described herein can be used as electrocatalyst in electrocatalytic applications including, but not limited to, hydrogen evolution reaction (HER), oxygen evolution reaction (OER), oxygen reduction reaction (ORR), carbon dioxide reduction reaction, electro-oxidation of instanceic acid (FAOR), and electrooxidation of methanol (MOR).

In some instances, the bacteria-based catalysts can be physically connected with an electrode by coating such as by spin-coating, drop-casting, or electropolymerization. In some instances, the bacteria-based catalysts can be added directly in an electrolyte solution for performing electrocatalytic reactions. In some instances, bacteria-based catalysts can include Geobacter sulfurreducens and Mn₂O₃ having amorphous structure. Bacteria-based catalysts employing these components have demonstrated a current density of 10 mA/cm² at an overpotential of about 390 mV vs. RHE, which outperforms commercially available Mn₂O₃ catalyst. In addition, the bacteria-based catalysts show operational stability for at least 24 hours.

In some instances, the bacteria-based catalysts described herein can be used as photocatalyst in photocatalytic applications including, but not limited to, solar cells, water splitting, organic pollutant degradation, and carbon dioxide reduction. Exemplary organic pollutants include, but are not limited to, pesticides such as DDT, Aldrin, chlordane, dieldrin, endrin, heptachlor, mirex, toxaphene, and lindane, industrial chemicals such as polychlorinated biphenyls, and substances such as dioxins, HCB, PCBs, and polychlorinated dibenzofurans.

In some instances, the bacteria-based catalysts described herein can be used in chemical catalysis applications including, but not limited to, the direct and selective oxidation of organic compounds (such as benzene to phenol; methane to methanol), C—H activation reactions, selective hydroxylation of organic compounds, and selective hydrogenation of organic compounds.

The present invention will be further understood by reference to the following non-limiting examples.

### EXAMPLES

The Examples below demonstrated for the first time bacteria-based catalysts, i.e. amorphous Mn₂O₃ nanocrystals directly synthesized by bacteria (B—Mn₂O₃), and their use in water oxidation as an outstanding electrocatalyst. The disclosed bacteria-based catalysts, i.e. B—Mn₂O₃. is highly effective for water oxidation or oxygen evolution reaction (OER). The method of making such catalysts, i.e. microbial mediated biosynthesis of Mn₂O₃ nanocrystals, eliminated the use of toxic reagents, can be performed under ambient conditions, and produced metal oxides, i.e. Mn₂O₃ nanocrystals, with undetectable levels of impurities. In the Examples, G. sulfurreducens was employed to synthesize manganese oxide nanocrystals by employing acetate as sole electron donor and KMnO₄ as the sole electron acceptor. As-synthesized manganese oxide showed a crystal structure of Mn₂O₃ with amorphous phase. The bacteria are bifunctional: (1) serving as reducing agent in the synthesis of Mn₂O₃ nanocrystals; and (2) serving as the supporting materials for the as-synthesized Mn₂O₃ nanocrystals, i.e. as carbon support. It was demonstrated that such B—Mn₂O₃ outperforms commercial Mn₂O₃ nanocrystals for OER.

### Example 1. Microbial Mediated Synthesis of Mn₂O₃ Nanocrystals

Materials and Methods

Bacterial Strain and Culture Conditions

G. sulfuredreducens strain (ATCC 51573) was used as the bacterium for the synthesis of B—Mn₂O₃. G. sulfurreducens is a gram-negative metal and sulfur reducing bacterium (Lovley, Annu. Rev. Microbiol., 66:391 (2012)). It is a metal reducing/electricigen bacteria with a known genome sequence (Methé, et al., Science, 302:1967-1969 (2003)) and it can be enriched from various ecosystems such as freshwater sediments, soil, anaerobic sludge, etc. G. sulfurreducens was cultured in an anaerobic serum bottle using acetate (10 mM) as electron donor and fumarate (50 mM) as electron acceptor in defined media (DM) (Bond, et al., Appl. Environ. Microbiol., 69:1548-1555 (2003)). The entire inoculation was conducted in an anaerobic glove box and the bottle was then kept for culturing in a shaking incubator (30° C.) for 5 days. After the incubation, the suspension was centrifuged, and the resultant cell suspension was washed with sterile anaerobic DM solution lacking fumarate three times prior to being inoculated for the synthesis of B—Mn₂O₃.

Synthesis of Manganese Oxide Nanocrystals by G. sulfuredreducens

In B—Mn₂O₃ synthesis, 5 mM KMnO₄ was added into 100 mL anaerobic DM solution containing 20 mM acetate as the sole electron donor in a septum vial (total 5 vials were used under same experimental conditions to confirm reproducibility). The cell suspension (optical density is ˜0.7)) after centrifugation were injected into the vial and incubated anaerobically at 30° C. in a dark room (to avoid direct contact with light) for 3 days. At the end of incubation period, the color of the solution was changed from purple to brown with the indication of Mn₂O₃ formation. The resulting solution was centrifuged at 8000 rpm for 5 minutes, then washed with Milli-Q water several times to remove media components and then dried overnight at 40° C. The dried sample (a mixture of rGO with dead cells) was used for further characterizations and electrocatalysis (OER).

Abiotic Control Experiment

The above experiment was conducted by keeping same experimental conditions without injecting bacterial cells to investigate the role of bacteria in Mn₂O₃ formation.

Results

The biosynthesis process of Mn₂O₃ nanocrystals is shown in FIG. 1. Under anaerobic condition, G. sulfurreducens oxidize acetate and the metabolically generated electrons are transported externally to cell wall-surrounded MnO₄⁻ions as the sole electron acceptor through a series of protein networks. As a result, MnO₄⁻(Mn⁴⁺) ions reduced to Mn₂O₃ (Mn³⁺) nanocrystals (B—Mn₂O₃), and decorated around the cell wall. High-Angle Annular Dark Field (HAADF) images showed that B—Mn₂O₃ nanocrystals were finely and uniformly decorated on the surface of bacterial cells with high uniform distribution. The bacterial cells were acted as the support materials (carbon support) for Mn₂O₃ nanocrystals.

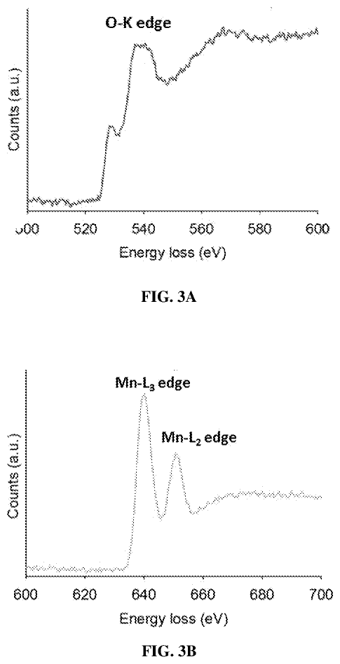

Energy-dispersive X-ray spectroscopy (EDX) analysis also showed the formation of B—Mn₂O₃ nanocrystals (See FIG. 2). HAADF image and EEL spectra of the bacteria showed that there was no Mn₂O₃ nanocrystals formation observed in the absence of G. sulfurreducnes cells. This result confirmed the role of bacteria on the nanocrystal instanceation (abiotic control experiment).

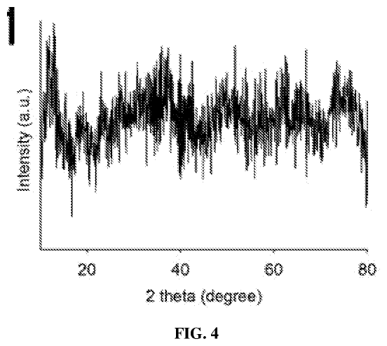

Electron energy-loss spectroscopy (EELS) in TEM is considered as a powerful tool to investigate the oxidation state of the nanomaterials (Jana, et al., Dalton Tran., 44:9158-9169 (2015)). EEL spectra of B—Mn₂O₃ nanocrystals showed two distinguished edges, Mn-L_{2,3} edge and O-K edge respectively, which demonstrated the instanceation of Mn₂O₃ nanocrystals (See FIGS. 3A-3B).

### Example 2. The B−Mn₂O₃ Nanocrystals are Amorphous in Nature

Materials and Methods

The B—Mn₂O₃ nanocrystals were measure with selected area electron diffraction (SAED) and X-ray diffraction (XRD). HAADF imaging and SAED were measured with commercial Mn₂O₃.

Results

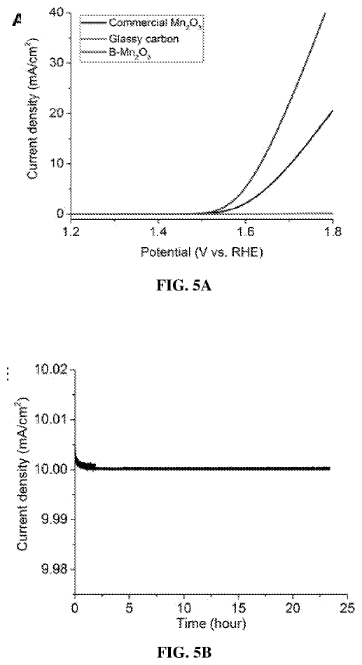

SAED and XRD analyses demonstrated that B—Mn₂O₃ nanocrystals are amorphous in nature. The XRD plot of B—Mn₂O₃ nanocrystals is shown in FIG. 4. HAADF image and SAED pattern showed that commercial Mn₂O₃ were crystalline in nature.

### Example 3. The B—Mn₂O₃ Nanocrystals are Highly Effective for Oxygen Evolution Reaction (OER)

Materials and Methods

The activity of the B—Mn₂O₃ towards the OER was tested using a rotating disc electrode (RDE). The working electrode was prepared by the following procedure: first, the B—Mn₂O₃ materials (˜2 mg) was dispersed in 500 μl of ethanol, 500 μl of water and 15 μl of Nafion (as binder). The dispersed solution was sonicated for 30 min. 2 μl of the obtained slurry was drop-coated onto a 3 mm glassy carbon disc electrode (GCE; loading concentration ˜0.049 mg/cm²) and dried under a lamp for 1 h. The electrochemical measurement was carried out using an electrochemical working station (BioLogic VMP3, France) in 1 M KOH (Sigma Aldrich, semiconductor grade, pellets, 99.99% trace metals basis) at room temperature using a three-electrodes system, in which Pt wire and Mercury/Mercury oxide reference electrode (Hg/HgO; 1 M NaOH) were used as counter and reference electrodes, respectively. Linear sweep voltammetry (LSV) experiments were performed at a scan rate of 10 mV/s while maintaining a constant rotational speed of 1600 rpm under the nitrogen environment. Commercial Mn₂O₃ (Sigma Aldrich) was used as a reference electrocatalyst to compare the catalytic activity of B—Mn₂O₃.

Results

The electrocatalytic activity of B—Mn₂O₃ nanocrystals for oxygen evolution reaction (OER) was investigated using linear sweep voltammetry (LSV) in 1M KOH at a scan rate of 10 mV/s. As a comparison, commercial Mn₂O₃ nanoparticles was tested under same OER conditions as the B—Mn₂O₃ nanocrystals for electrocatalytic activities. As-synthesized B—Mn₂O₃ amorphous nanocrystals showed the highest OER performance with an overpotential of 390 mV vs. reversible hydrogen electrode (RHE) to produce a geometric current density of 10 mA/cm² while commercial crystalline Mn₂O₃ showed an overpotential of 470 mV (McCrory, et al., J. Am. Chem. Soc., 135:16977-16987 (2013)) (See FIG. 5A). There was no OER activity with bare glassy carbon (GC) (See FIG. 5A). Without wishing to be bound by theory, the improved OER activity of B—Mn₂O₃ nanocrystals over commercial Mn₂O₃ can be attributed to their amorphous structure and uniform distribution on the bacterial cell surface. Also, Mn³⁺ is believed to be the key player in OER over other valence states of manganese oxides (Takashima, et al., J. Am. Chem.Soc., 134:1519-1527 (2012)).

### Example 4. The OER Activities of B—Mn₂O₃ Nanocrystals is Stable for at Least 24 Hours

Materials and Methods

The stability of B—Mn₂O₃ nanocrystals was tested using chronoamperomtery experiment by applying an overpotential of 390 mV.

Results

OER activity of B—Mn₂O₃ nanocrystals is stable even after 24 hours of testing (See FIG. 5B).

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A catalyst comprising:
a bacterium; and
one or more metal oxides,
wherein the metal oxides are dispersed on the surface of the bacterium.

2. The catalyst of claim 1, wherein the metal oxide is dispersed uniformly on the surface of the bacterium.

3. (canceled)

4. The catalyst of claim 1, wherein the bacterium is an electrogenic bacterium selected from the group consisting of Geobacter sulfurreducens, Desulfuromonas acetexigens, Geobacter metallireducens, Shewanella oneidensis MR-1, Shewanella putrefaciens IR-1, Clostridium butyricum, Rhodoferax ferrireducens, Aeromonas hydrophilia (A3), Desulfobulbus propionicus, Shewanella oneidensis DSP10, Rhodoseudomonas palustris, Geothrix fermentans, and Geopsychrobacter electrodiphilus.

5. (canceled)

6. The catalyst of claim 1, wherein the bacterium is Geobacter sulfurreducens.

7. (canceled)

8. (canceled)

9. (canceled)

10. The catalyst of claim 1, wherein the metal oxide is selected from the group consisting of chromium oxide, manganese oxide, iron oxide, cobalt oxide, nickel oxide, copper oxide, zinc oxide, ruthenium oxide, rhodium oxide, palladium oxide, silver oxide, cadmium oxide, iridium oxide, platinum oxide, and gold oxide.

11. The catalyst of claim 1, wherein the metal oxide is manganese oxide.

12. (canceled)

13. The catalyst of claim 1, wherein the metal oxide is doped with one or more elements other than the metal.

14. The catalyst of claim 13, wherein the one or more elements are selected from the group consisting of aluminum, indium, gallium, silicon, tin, chromium, manganese, iron, cobalt, nickel, copper, zinc, ruthenium, rhodium, palladium, silver, cadmium, iridium, platinum, gold, potassium, carbon, phosphorous, sulfur, fluorine, chlorine, bromine, and iodine.

15. (canceled)

16. The catalyst of claim 1, wherein the catalyst is an electrocatalyst or a photocatalyst.

17. (canceled)

18. The catalyst of claim 16, wherein the catalyst catalyzes an oxygen evolution reaction.

19. The catalyst of claim 17, wherein the oxygen evolution reaction has an overpotential of about 390 mV vs. RHE at a current density of 10 mA/cm².

20. The catalyst of claim 1, wherein the catalyst shows operational stability for at least 24 hours.

21. A method of making the catalyst of claim 1, comprising:
(a) oxidizing a substrate molecule by a bacterium to generate electrons;
(b) transporting the electrons to one or more metal oxide precursors; and
(c) reducing the metal oxide precursors to one or more metal oxides.

22. The method of claim 20, wherein the bacterium is an electrogenic bacterium selected from the group consisting of Geobacter sulfurreducens, Desulfuromonas acetexigens, Geobacter metallireducens, Shewanella oneidensis MR-1, Shewanella putrefaciens IR-1, Clostridium butyricum, Rhodoferax ferrireducens, Aeromonas hydrophilia (A3), Desulfobulbus propionicus, Shewanella oneidensis DSP10, Rhodoseudomonas palustris, Geothrix fermentans, and Geopsychrobacter electrodiphilus.

23. The method of claim 20, wherein the electrons generated in step (a) is transported externally to the metal oxide precursors and optionally, the metal oxides are dispersed on the surface of the bacterium.

24. (canceled)

25. (canceled)

26. The method of claim 20, wherein: (a) steps (a)-(c) are performed in an anaerobical environment, or (b) steps (a)-(c) are performed under ambient conditions.

27. (canceled)

28. The method of claim 20, wherein the substrate molecule is acetate, hydrogen, lactate, pyruvate, instanceate, phosphite, sulfur, sulfite, or thiosulfate.

29. The method of claim 20, wherein the substrate molecule is acetate.

30. The method of claim 20, wherein the metal oxide precursors are one or more salts of a transition metal selected from the group consisting of chromium, manganese, iron, cobalt, nickel, copper, zinc, ruthenium, rhodium, palladium, silver, cadmium, iridium, platinum, and gold.

31. (canceled)

32. The method of claim 20, wherein the metal oxide precursor is potassium permanganate.
